(19) United States
(12) Patent Application Publication
(10) Pub. No.: US 2006/0133413 A1
(43) Pub. Date: Jun. 22, 2006

(54) Retaining capability of handling original type messages in an upgraded computer system

(75) Inventor: Laurent Pierre Francois Bousis, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/525,484

(22) PCT Filed: Jul. 24, 2003
(86) PCT No.: PCT/IB03/03328

§ 371 Date: Feb. 23, 2005

(30) Foreign Application Priority Data
Aug. 30, 2002 (EP) 02078569.7

(51) Int. Cl. H04L 12/56; H04J 3/16

(52) U.S. Cl. 370/466; 370/401

(57) ABSTRACT

The present invention relates to a method, a gateway (10), an internal network, a computer program product and a computer program element, where the gateway includes a first port (30) connected to an external network for transmission of messages according to a first protocol and having a first address according to the first protocol, where transmitted messages comprise messages including embedded messages according to a second protocol and original messages according to the first protocol, a second port (32) connected to a first part of the internal network and a control unit (36), which assigns the second port as a port to be used for all messages not including embedded messages, assigns a second address to the second port, which is closely related to the address of the first port, and informs the first part of the internal network about the second port and its address.

The present invention generally relates to the field of communication in computer systems and more particularly to the interface between internal and external computer networks. The present invention furthermore relates to a method and device for handling messages in an interface between an internal network and an external network as well as to a computer program product and a computer program element including program code for performing said method.

There has in recent years been an upgrading of addressing protocols in the computer communication field. For instance regarding the Internet Protocol there has been an upgrading from a version 4 or IPv4 to a version 6 or IPv6. This upgrading has resulted in among other things more advanced functions in the addressing protocol, like higher security.

So far external networks like the Internet still uses IPv4, while quite a few internal networks use IPv6. This means that outgoing traffic from an internal network to another site, which both use IPv6, need to be embedded or encapsulated in messages according to IPv4 when passing the Internet today.

There has therefore been developed gateways for internal networks having the ability to embed or encapsulate IPv6 packets in IPv4 packets and to decapsulate or extract such packets. The Internet Engineering Task Force (IETF) in RFC3056 by B. Carpenter and K. Moore, February 2001 describes one such method.

When putting such gateways in a local network there is however a problem of having older devices, which work solely with IPv4, work with such a new gateway.

The article “DTTS: A Transparent and Scalable Solution for IPv4 to IPv6 Transition”, by Kai Wang. Ann-Kian Yeo and A. L. Ananda, proceedings of the 10^{th} ICCCN 2001, Scottsdale, Ariz., 15-17 Oct. 2001, USA, pp 248-253, describes local devices within a local network using IPv4 packets. The whole local network uses IPv6 as transport mechanism though, which means that in order to combine IPv4 packets to and from computers in the local network, these have to be embedded in IPv6 packets before they reach a gateway where the IPv6 packets are extracted before they are sent on an external network using IPv4.

As yet there exist no real simple and cheap solution of how to combine this new technology with older technology without providing complicated and expensive routing and message packing equipment.

One object of the present invention is to provide a method that enables equipment that uses a first addressing protocol to be combined with equipment that uses a second addressing protocol without having to add new and expensive equipment for handling the old protocols and that avoids discarding old equipment using the first protocol.

According to a first aspect of the present invention, this object is achieved by a method of handling messages in an interface between an external network and an internal network comprising the steps of: setting a first address according to a first addressing protocol to be used on a first port connected to the external network for transmission of messages according to the first protocol, where transmitted messages comprise messages including embedded messages according to a second addressing protocol and original messages according to the first protocol, assigning a second port connected to a first part of the internal network as a port to be used for all messages not including embedded messages, assigning a second address to the second port, which is closely related to the address of the first port, and informing the first part of the internal network about the second port and its address, such that original messages according to the first protocol can be transferred between the internal network and the external network.

Another object of the present invention is to provide an interface device that enables equipment that uses a first addressing protocol to be combined with equipment that uses a second addressing protocol without having to add new and expensive equipment or functionality for handling the old protocols and that avoids discarding old equipment using the first protocol.

According to a second aspect of the invention this object is achieved by an interface device for routing of messages between an external network and an internal network including: a first port connectable to the external network for transmission of messages according to a first addressing protocol and having a first address according to the first protocol, where transmitted messages comprise messages including embedded messages according to a second addressing protocol and original messages according to the first protocol, a second port connectable to a first part of the internal network and a control unit arranged to: assign the second port as a port to be used for all messages not including embedded messages, assign a second address to the second port, which is closely related to the address of the first port, and inform the first part of the internal network about the second port and its address, such that original messages according to the first protocol can be transferred between the internal network and the external network.

Yet another object of the present invention is to provide an internal network that enables equipment within the internal network that uses a first addressing protocol to be combined with equipment within the internal network that uses a second addressing protocol without having to add new and expensive equipment or functionality for handling the old protocols and that avoids discarding old equipment using the first protocol.

According to a third aspect of the invention this object is achieved by an internal network for communicating with an external network comprising a first part and an interface device connectable between the first part and the external network. The interface device comprises a first port connectable to the external network for reception of messages sent according to the first protocol and having a first address according to a first addressing protocol, where received messages comprise messages including embedded messages according to a second addressing protocol and original messages according to the first protocol, a second port connected to the first part of the internal network and a control unit arranged to: assign the second port as a port to be used for all messages not including embedded messages, assign a second address to the second port, which is closely related to the address of the first port, and inform the first part of the internal network about the second port and its address, such that original messages according to the first protocol can be transferred between the internal network and the external network.

Yet another object of the present invention is to provide a computer program product and a computer program element that enables equipment that uses a first addressing protocol to be combined with equipment that uses a second addressing protocol without having to add new and expensive equipment or functionality for handling the old protocols and that avoids discarding old equipment using the first protocol.

According to a fourth aspect of the invention this object is achieved by a computer program product and a program element to be used on a computer connectable between an internal and an external network and having a first address according to a first addressing protocol to be used on a first port connectable to the external network for transmission of messages according to the first protocol, where transmitted messages comprise messages including embedded messages according to a second addressing protocol and original messages according to the first protocol, said computer program element and computer program product comprising: computer program code means, to make the computer execute, when said program is loaded in the computer: assigning a second port connectable to a first part of the internal network as a port to be used for messages not including embedded messages, assigning a second address to the second port, which is closely related to the address of the first port, and informing the first part of the internal network about the second port and its address, such that original messages according to the first protocol can be transferred between the internal network and the external network.

The present invention has the advantage of being cheap and simple to implement in already existing interface devices. Another advantage is that old equipment when combined with the invention will not experience any change of the environment. It will continue to function as before, which leads to a seamless integration of newer and older technology. The present invention has the further advantage in that the interface device can be kept simple in that functionality in already existing interface devices in the internal network need not be duplicated, but can be used as before.

The general idea behind the present invention is to provide an interface device which on one hand is seen as being transparent to a first part of an internal network using a first protocol and on the other hand is able to decapsulate and route embedded messages according to a second protocol to a second part of the internal network.

These and other aspects of the invention will be apparent from and elucidated with reference to the embodiments described hereinafter.

The present invention will now be explained in more detail in relation to the enclosed drawings, where

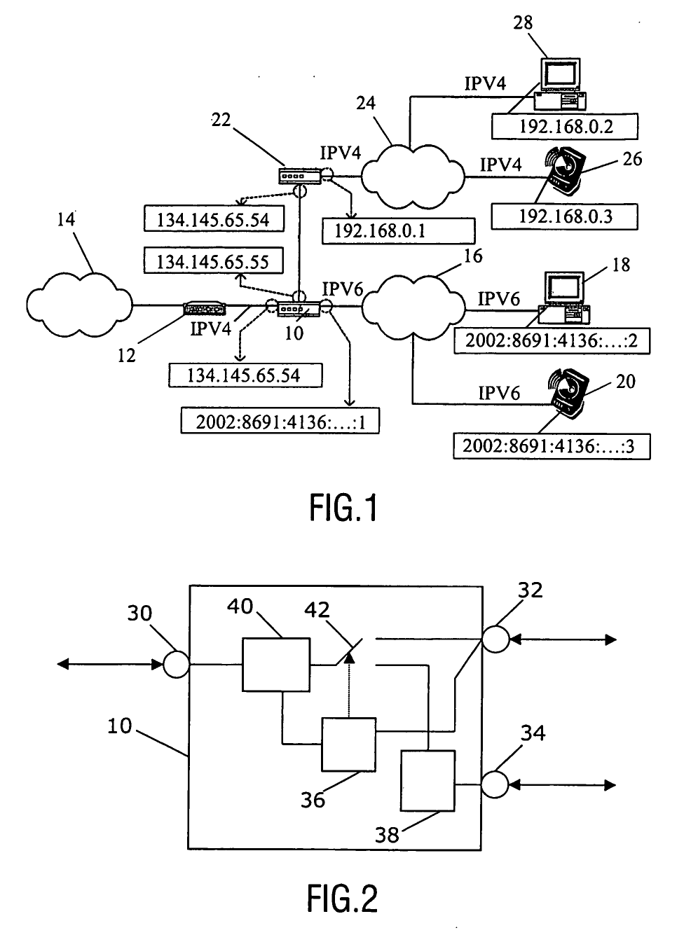

FIG. 1 shows a schematic drawing of an external network connected to an internal network via a gateway according to the invention,

FIG. 2 shows a block schematic of the gateway according to the present invention,

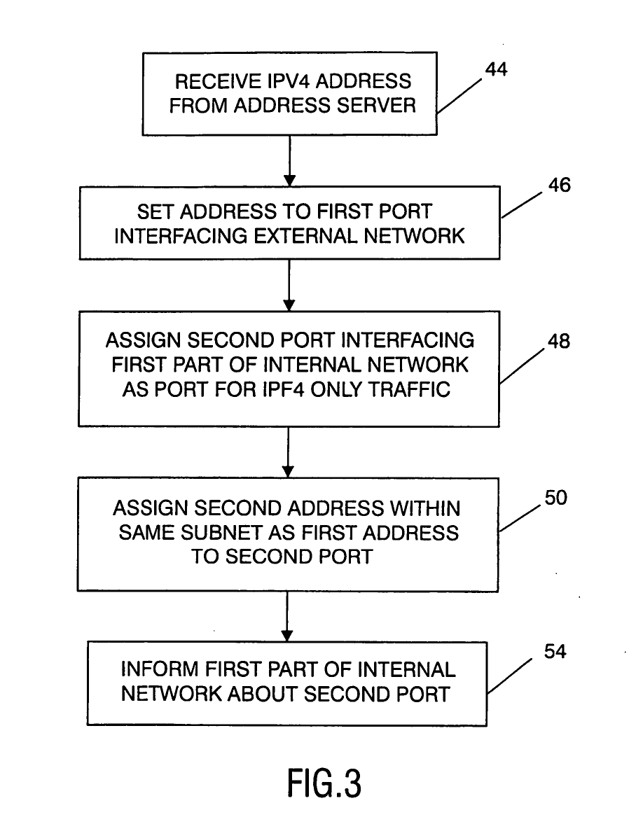

FIG. 3 shows a flow chart of a method according to the invention,

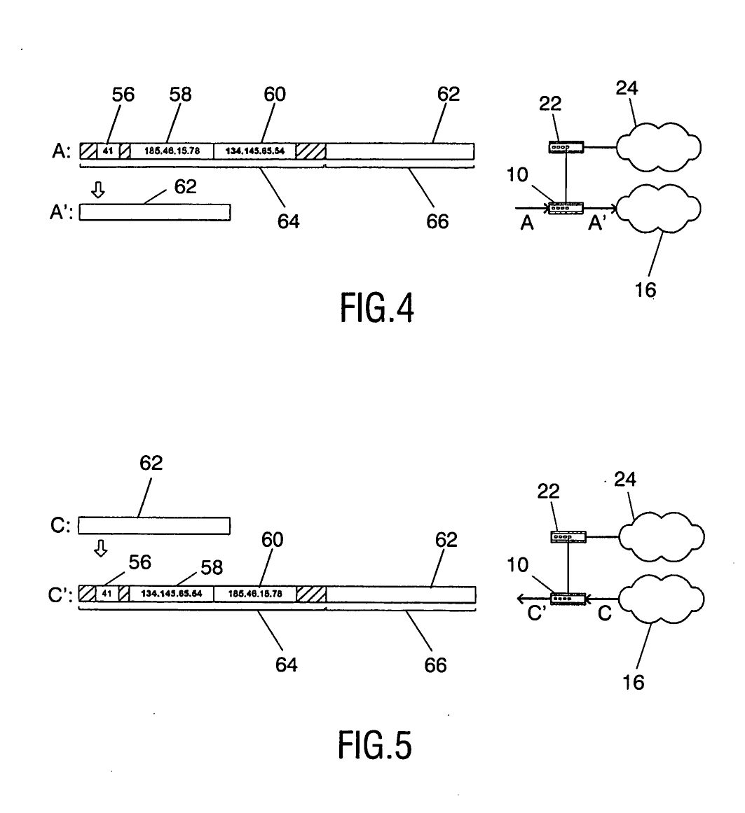

FIGS. 4-7 show a number of messages or packets sent from the gateway according to the invention together with related parts of the internal and external network where the messages are sent, and

FIG. 8 shows schematically a computer readable medium on which is stored program code for performing the method according to the invention.

FIG. 1 shows a schematic drawing of the invention and it's environment. In FIG. 1 there is shown an interface device 10 according to the invention connected to an external network 14 and in this case connected to the Internet via a modem 12 and connected to an internal or home network. The interface device 10 routes messages between the external and internal network and is in the preferred embodiment of the invention a first gateway 10. The first gateway 10 is connected to a first part 24 of the internal network via a second gateway 22 and to a second part 16 of the internal network. The first part 24 of the internal network includes a first PC 28 and a first Internet Radio 26. The second part 16 of the internal network includes a second PC 18 and a second Internet Radio 20. It should be realized that both the first and second parts of the internal network can include more or fewer devices, for instance in the form of more PCs and Internet Radios as well as printers, scanners or any other type of computer equipment which can be connected in computer networks using an address. The external network 14 uses a first type of addressing protocol, which in this embodiment is the Internet Protocol version 4 or IPv4. The first part 24 of the internal network uses the same type of addressing, i.e. IPv4, while the second part 16 of the internal network uses a different and improved addressing protocol and in this preferred embodiment Internet Protocol version 6, i.e. IPv6. This means that the first part 24 of the internal network receives messages using the first addressing protocol, while the second part 16 receives messages having the second addressing protocol. The different devices, i.e. PCs, Internet Radios, and gateways of the internal network are shown as having different addresses, the significance of which will be described later.

A simplified version of the gateway 10 according to the invention is shown in a block schematic in FIG. 2. The first gateway 10 has a first port 30 connected to the Internet via the modem (not shown). The first port 10 is connected to an input register 40 for incoming messages, which register is connected to a control unit 36 as well as to a switch 42, which switch is controlled by the control unit 36. A dashed arrow indicates the control. The switch is with one contact point connected to a second port 32, which port is also connected to the control unit 36, and with another contact point to an encapsulation/decapsulation unit 38, which encapsulation/decapsulation unit is connected to a third port 34. The second port 32 is connected to the first part of the internal network (not shown) while the third port is connected to the second part of the internal network (also not shown).

Now a method according to the invention will be described with reference to FIGS. 1, 2 and 3, where FIG. 3 shows a flow chart over the method according to the invention. The local network is connected to the Internet 14 via the modem 12. When a user of the local network wants to use the Internet, the first gateway 10 connects to an Internet Service Provider ISP (not shown) via the first port 30 and the modem 12. This connection is set up using the IPv4 addressing protocol. The ISP will have access to an address server in the form of a DHCP (Dynamic Host Configuration Protocol), a PPP (Point-to-Point Protocol) or PPPoE (Point-to-Point Protocol over Ethernet) server, which then gives the first gateway 10 connected to the modem an Internet address. This address is communicated from the ISP to the first port of the first gateway 10, step 44, from where it is forwarded to the control unit 36. The first port 30 thus receives the address from the ISP. In the message where this address is sent, the gateway also receives information about subnet mask, i.e. on what network the first gateway 10 is located and the address to the next gateway of the address structure, which is hierarchical in nature. The address of the first port 30, which is also the address to which all traffic to the internal network has to be sent from the external network over the Internet, is here indicated as being 134.145.65.54. The subnet mask would then be 255.255.255.0, in order to identify the subnet address 134.145.65 after an AND operation of the subnet mask with the address of the first gateway 10. The gateway for devices inside the subnet could then be 134.145.65.254, which thus is the gateway with which the first gateway communicates. The first port 30, which interfaces the external network, is thus set with this address, step 46. The control unit 36 of the gateway 10 does this setting of address after it has received and processed the information from the ISP. The control unit 36 thereafter assigns the second port 32, which interfaces the first part 22 of the internal network as a port for IPv4 only traffic, step 48, or rather as a port for receiving all messages not containing embedded IPv6 packets. How embedded IPv6 packets are handled will be described in more detail later on in this description. The control unit 36 then assigns a second address to the second port which address is the address 134.145.65.55, step 50. This address does not have to be the next higher address as exemplified above, but it has to be closely related to the first address, i.e. that the address belongs to the same subnet as the first address or is at the same hierarchical level within the same addressing system as the first address. The second address can however not be a freely made up IP address, since then messages would be stopped because the second gateway, if it wishes to send a packet to the first gateway, would not know how to reach that IP address. If the addresses are on the same subnet the second gateway knows it just has to drop messages on the subnet (which is a shared medium) and that it will arrive at the first gateway. Finally the control unit 36 informs the first part of the internal network or rather the second gateway 22 of the first part of the internal network about the address of the second port, step 54. This second gateway 22 is used as an interface between the first gateway 10 and the first part 24 of the internal network. This is done in the same way as the first gateway received its address from the ISP, i.e. by giving the second gateway the same address and subnet mask as the first port of the first gateway and indicating the address of the second port as the address of the default gateway to route messages to. This port has thus been assigned as default port for the second gateway 22. It should here be noted that the second address probably exists somewhere else in the Internet, but since it is only used internally in the internal network this does not matter. The control unit 36 then processes all messages not including embedded IPv6 messages received on the first port as messages to be transferred to the second port 32 and processes all messages received on the second port 32 as messages to be transferred to the Internet. By informing the second gateway 22 in the above-described way, the second gateway 22 will forward all IPv4 messages it cannot route to the first gateway. It should be realized that the actual addresses used above are mere examples of addresses, which have only been chosen in order to describe the functioning of the invention.

It should also be noted here that the second gateway 22 does a network address port translation (NAPT) of transmitted messages, since it has a port interfacing the rest of the first part of the internal network. The devices on this internal network receive internal addresses 192.168.0.1 for the second gateway 22, 192.168.0.2 for PC 28 and 192.168.0.3 for Internet Radio 26. This could be done by using DHPC (Dynamic Host Configuration Protocol). How this is done is not new and is not part of the present invention. It is thus well known to the man skilled in the art how this type of address conversion takes place in an internal network. It is sufficient to say that it is normally necessary if several devices are sharing the same Internet address. It should be realized that the actual addresses used above are mere examples of addresses, which have only been chosen in order to describe the invention.

The first gateway 10 has in the same way packet encapsulation/decapsulation or tunneling capabilities for messages including embedded IPv6 packets for the second part 16 of the internal network. Therefore the third port 34 of the first gateway 10 receives an address 2002:8691:4136: . . . :1, PC 18 receives address 2002:8691:4136: . . . :2 and Internet Radio 20 receives address 2002:8691:4136: . . . :3. Also these addresses are internal and structured, but then according to the IPv6 protocol. The encapsulation/decapsulation of IPv6 packets in IPv4 packets will be described shortly; although it is also previously known how this is encapsulation/decapsulation is done. It should be realized that the actual addresses used above are mere examples of addresses, which have only been chosen in order to describe the invention.

How the routing of messages takes place in the system according to the invention will now be described in relation to FIGS. 1, 2, 4, 5, 6 and 7, where FIGS. 4-7 show different signal formats together with schematic drawings of the paths they take in the network.

Incoming IPv4 packets are received from the Internet on the first port 30 of the first gateway 10 and forwarded to input register 40. FIG. 4 shows such a message A having a header 64 including a protocol field 56, a source address 58 and a destination address 60 as well as the path the message takes. The packet, which is an IPv4 packet, also includes a payload 66, which is in fact an embedded IPv6 packet 62. The control unit 36 investigates the protocol field 56 and notices the code therein, code 41, which indicates that the message contains an embedded IPv6 message. Therefore the control unit actuates switch 42 to connect to the encapsulation/decapsulation unit 38. The message is then forwarded from the input register 40 to the encapsulation/decapsulation unit 38. This encapsulation/decapsulation unit then extracts the IPv6 message 62 from the IPv4 message. The extracted IPv6 message already has an address according to the IPv6 protocol which is used for forwarding the message on the third port to an appropriate receiving device as message A′.

FIG. 5 shows a message C received from the second part 16 of the internal network on the third port 34 as well as the path this message takes. This message has the same type of structure as the previously described message A′ and is forwarded to the encapsulation/decapsulation unit 38, which encapsulates or embeds the IPv6 message in an IPv4 message. The IPv4 addresses 58, 60 are then added in a known way and the protocol field 56 is set for indicating embedded IPv6 messages. The complete message includes the same type of fields as the previously described message A. The thus created IPv4 message C′ is then sent to the Internet via the first port 30.

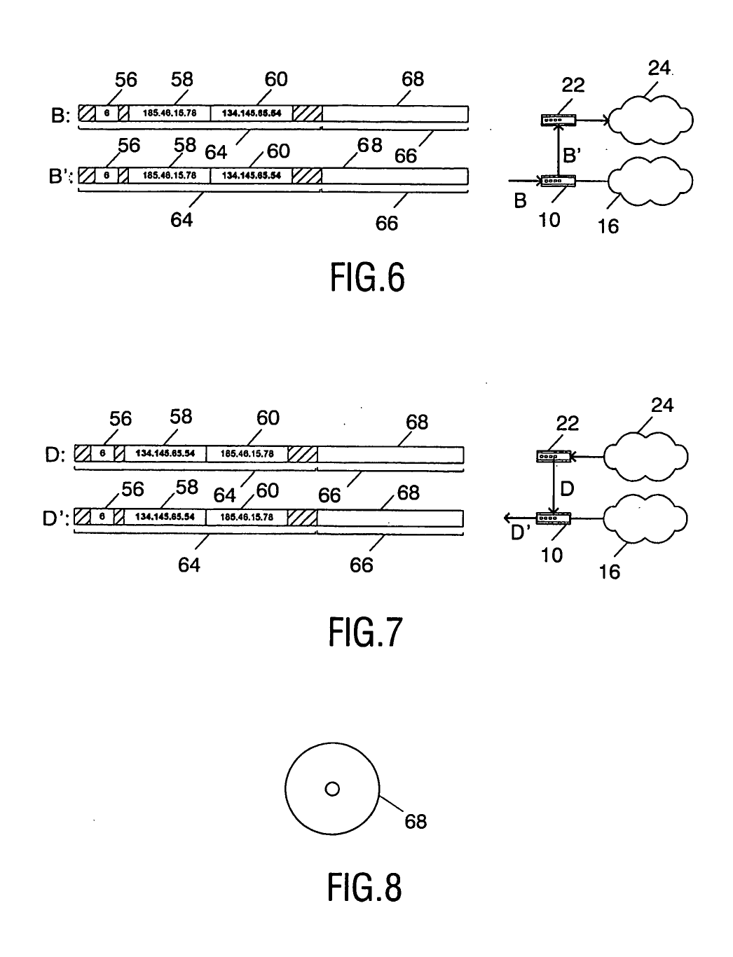

The handling of incoming ordinary IPv4 messages will now be described in relation to FIG. 6, which also shows the path a message, is taking. A message B is now received on the first port 30 of the first gateway 10 and then forwarded to the input register 40. The message includes a header 64 including a protocol field 56, a source address field 58 and a destination address field 60 as well as a payload 66 including a TCP packet 68. The control unit 36 looks at the protocol field 56, notices that this field does not indicate an encapsulated IPv6 packet, but a TCP packet, code 6. Because the protocol field did not indicate an embedded IPv6 message, the control unit then actuates switch 42 to connect to the second port 32 and forwards this message directly to the second port 32, which in turn sends the same message B′ to the second gateway 22 interfacing the first part 24 of the internal network. In the second gateway 22 the message is translated in the previously described way. Because all non-encapsulated IPv6 messages are forwarded to the second gateway, the capabilities this second gateway has for taking care of other types of messages, for instance UDP messages having code 17, are still used. This also makes the first gateway simpler in that it only separates between original IPv4 messages and encapsuled IPv6 messages, which it decapsulates and encapsulates.

An outgoing ordinary IPv4 message D is shown in FIG. 5 together with its path in the internal network. This message is sent from the first part 24 of the internal network and received on the second port 32 of the first gateway 10. The control unit 36 then transfers this message to the first port 30, from where it is transferred as output message D′ to the Internet without modification. These messages D and D′ have identical structure with messages B and B′. Thus messages can be routed to and from an old part of an internal network without any additional components or work being performed in the first gateway.

The different units in the gateway are normally provided in the form of one or more processors together with suitable program memory containing appropriate program code for performing the method according to the invention and the routing according to the invention. The software or program code for performing this can also be provided on a computer program product in the form of a computer readable medium, which will perform the method according to the invention when loaded into the first gateway, which is in fact a sort of computer. One such medium in the form of a CD Rom 68 is depicted in FIG. 8, although there are many different mediums possible such as diskettes. The software can also be provided in the form of firmware upgrades downloaded from another server.

The present invention thus provides a gateway, a method, a program product and a program code, which facilitates use of old equipment together with new equipment, when the address protocol has been upgraded or changed. In this way old equipment can be combined with new equipment without having to do expensive and time-consuming adjustments.

The second gateway does moreover not realize that it is not communicating directly with the Internet, why the first part of the old network can be easily incorporated with a new network. By providing this solution which retains the functionality of the second gateway, like network address translation, a dhcp server for private addresses, firewall, etc. this functionality does not have to be duplicated in the first gateway, which keeps the cost of the first gateway low.

There are a number of possible variations to the invention, which can be made.

It should be realized that the first part of the internal network does not have to include the second gateway connected to the second port. In fact in its simplest version there might be only one computer connected to the second port. There might also be a network of devices connected to the second port, which all receive the same type of notice from the first gateway as the second gateway did.

Routing of messages to and from the first part of the network can furthermore be performed using a positive identification of original IPv4 messages. In this case only a protocol field indicating an IPv4 message would lead to a routing of the message to the first part of the internal network. The gateway would then need to have some function for handling messages not having this type of indication or the IPv6 type of indication of the protocol field. This variant is in fact less satisfactory than the preferred solution because of the extra functionality needed in the first gateway.

It should also be understood that the gateway described could include several more input registers as well as a number of output registers. The numbers have intentionally been kept low for getting a better understanding of the invention. The switch in the first gateway is furthermore normally provided in the form of software.

The invention is furthermore possible to implement in a system with fixed addresses. In this case the first gateway would be permanently connected to the Internet and the first address received only once.

The invention is furthermore not limited to IPv4 and IPv6. It is just as relevant for any other upgrade of address protocol, for instance for an upgrade from version 6 to yet a higher version. The invention is in fact not limited to IP addressing either, but can be implemented in any suitable hierarchical addressing protocol.

The networks do also not need to be fixed networks, but can also for instance be wireless.

1. Method of handling messages in an interface between an external network and an internal network comprising the steps of:
setting a first address according to a first addressing protocol to be used on a first port connected to the external network for transmission of messages according to the first protocol, where transmitted messages comprise messages including embedded messages according to a second addressing protocol and original messages according to the first protocol,
assigning a second port connected to a first part of the internal network as a port to be used for all messages not including embedded messages,
assigning a second address to the second port, which is closely related to the address of the first port, and
informing the first part of the internal network about the second port and its address, such that original messages according to the first protocol can be transferred between the internal network and the external network.

2. Method according to claim 1, wherein the step of assigning the second port as a port to be used comprises setting the port as a default port for the first part of the internal network.

3. Method according to claim 1, wherein the address of the second port belongs to the same subnet as the address of the first port.

4. Method according to claim 1, wherein the address of the second port is at the same hierarchical level in the same addressing system as the address of the first port.

5. Method according to claim 1, further including the steps of:
receiving at least one message according to the first addressing protocol on the first port,
determining if the message includes an embedded message according to the second addressing protocol, and
in case the message does not include an embedded message according to the second protocol, forwarding the message unchanged to the second port for sending to the first part of the internal network.

6. Method according to claim 5, wherein the step of determining includes analyzing the protocol field of the message header and determining that it is a message including an embedded message if the protocol field indicates this.

7. Method according to claim 5, further including the step of in case the message includes an embedded message extracting the embedded message according to the second protocol from the message according to the first protocol and forwarding the extracted message to a second part of the internal network.

8. Interface device for routing of messages between an external network and an internal network including:
a first port connectable to the external network for transmission of messages according to a first addressing protocol and having a first address according to the first protocol, where transmitted messages comprise messages including embedded messages according to a second addressing protocol and original messages according to the first protocol,
a second port connectable to a first part of the internal network and a control unit arranged to:
assign the second port as a port to be used for all messages not including embedded messages,
assign a second address to the second port, which is closely related to the address of the first port, and
inform the first part of the internal network about the second port and its address, such that original messages according to the first protocol can be transferred between the internal network and the external network.

9. Device according to claim 8, wherein the control unit is arranged to set the second port as a default port for the first part of the internal network and communicate this to the first part of the internal network.

10. Device according to claim 8, wherein the address of the second port belongs to the same subnet as the address of the first port.

11. Device according to claim 8, wherein the address of the second port is at the same hierarchical level in the same addressing system as the address of the first port.

12. Device according to claim 8, wherein the first port receives at least one message according to the first addressing protocol, and the control unit is further arranged to:
determine if the message includes an embedded message according to the second addressing protocol, and
to forward, in case the message does not include an embedded message according to the second protocol, the message unchanged to the second port for sending to the first part of the internal network.

13. Device according to claim 12, wherein the control unit is arranged to analyze the protocol field of the received message header and treating the message as a message including an embedded message if the protocol field indicates this.

14. Device according to claim 12, wherein the control unit is arranged to, in case the message includes an embedded message, extract the message according to the second protocol from the message according to the first protocol and forward the extracted message to a third port for sending to a second part of the internal network.

15. An internal network for communicating with an external network comprising:
a first part and
an interface device connectable between the first part and the external network, said interface device comprising:
a first port connectable to the external network for reception of messages sent according to the first protocol and having a first address according to a first addressing protocol, where received messages comprise messages including embedded messages according to a second addressing protocol and original messages according to the first protocol,
a second port connected to the first part of the internal network, and
a control unit arranged to:
assign the second port as a port to be used for all messages not including embedded messages,
assign a second address to the second port, which is closely related to the address of the first port, and
inform the first part of the internal network about the second port and its address, such that original messages according to the first protocol can be transferred between the internal network and the external network.

16. Computer program product comprising a computer readable medium to be used on a computer connectable between an internal and an external network and having a first address according to a first addressing protocol to be used on a first port connectable to the external network for transmission of messages according to the first protocol, where transmitted messages comprise messages including embedded messages according to a second addressing protocol and original messages according to the first protocol, said computer readable medium having thereon:
computer program code means, to make the computer execute, when said program is loaded in the computer:
assigning a second port connectable to a first part of the internal network as a port to be used for messages not including embedded messages,
assigning a second address to the second port, which is closely related to the address of the first port, and
informing the first part of the internal network about the second port and its address, such that original messages according to the first protocol can be transferred between the internal network and the external network.

17. Computer program element to be used on a computer connectable between an internal and an external network and having a first address according to a first addressing protocol to be used on a first port connectable to the external network for transmission of messages according to the first protocol, where transmitted messages comprise messages including embedded messages according to a second addressing protocol and original messages according to the first protocol, said computer program element comprising:
computer program code means, to make the computer execute, when said program is loaded in the computer:
assigning a second port connectable to a first part of the internal network as a port to be used for messages not including embedded messages,
assigning a second address to the second port, which is closely related to the address of the first port, and
informing the first part of the internal network about the second port and its address, such that original messages according to the first protocol can be transferred between the internal network and the external network.
